(19) United States
(12) Patent Application Publication
(10) Pub. No.: US 2024/0195230 A1
(43) Pub. Date: Jun. 13, 2024

(54) WIRELESS ENERGY TRANSFER SERVICE

(71) Applicant: QUALCOMM Incorporated, San Diego, CA (US)

(72) Inventors: Xiaojie Wang, Hillsborough, NJ (US); Navid Abedini, Basking Ridge, NJ (US); Junyi Li, Fairless Hills, PA (US)

(21) Appl. No.: 18/065,008

(22) Filed: Dec. 13, 2022

(51) Int. Cl. H02J 50/80

(52) U.S. Cl. CPC H02J 50/80

(57) ABSTRACT

This disclosure provides systems, methods, and devices for wireless communication that support a wireless energy transfer service. In a first aspect, a method of wireless communication includes receiving, by a first network node from a second network node, an indication that the second network node supports wireless energy transfer, transmitting, by the first network node to the second network node, a request for wireless energy transfer based on receipt of the indication that the second network node supports wireless energy transfer, and receiving, by the first network node from the second network node, energy for one or more components of the first network node after transmitting the request for wireless energy transfer. Other aspects and features are also claimed and described.

### TECHNICAL FIELD

Aspects of the present disclosure relate generally to wireless communication systems, and more particularly, to energy transmission in a wireless network. Some features may enable and provide improved communications, including a wireless energy transfer service operating in a wireless network.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication includes receiving, by a first network node from a second network node, an indication that the second network node supports wireless energy transfer, transmitting, by the first network node to the second network node, a request for wireless energy transfer based on receipt of the indication that the second network node supports wireless energy transfer, and receiving, by the first network node from the second network node, energy for one or more components of the first network node after transmitting the request for wireless energy transfer.

In an additional aspect of the disclosure, a first network node includes at least one processor and a memory coupled to the at least one processor. The at least one processor is configured to receive, from a second network node, an indication that the second network node supports wireless energy transfer, transmit, to the second network node, a request for wireless energy transfer based on receipt of the indication that the second network node supports wireless energy transfer, and receive, from the second network node, energy for one or more components of the first network node after transmitting the request for wireless energy transfer.

In an additional aspect of the disclosure, a first network node includes means for receiving, by the first network node from a second network node, an indication that the second network node supports wireless energy transfer, means for transmitting, by the first network node to the second network node, a request for wireless energy transfer based on receipt of the indication that the second network node supports wireless energy transfer, and means for receiving, by the first network node from the second network node, energy for one or more components of the first network node after transmitting the request for wireless energy transfer.

In an additional aspect of the disclosure, a non-transitory computer-readable medium stores instructions that, when executed by a processor, cause the processor to perform operations. The operations include receiving, by a first network node from a second network node, an indication that the second network node supports wireless energy transfer, transmitting, by the first network node to the second network node, a request for wireless energy transfer based on receipt of the indication that the second network node supports wireless energy transfer, and receiving, by the first network node from the second network node, energy for one or more components of the first network node after transmitting the request for wireless energy transfer.

In an additional aspect of the disclosure, a method for wireless communication includes transmitting, by a first network node to a second network node, an indication that the first network node supports wireless energy transfer, receiving, by the first network node from the second network node, a request for wireless energy transfer, and transmitting, by the first network node to the second network node, energy for one or more components of the second network node after transmitting the request for wireless energy transfer.

In an additional aspect of the disclosure, a first network node includes at least one processor and a memory coupled to the at least one processor. The at least one processor is configured to transmit, to a second network node, an indication that the first network node supports wireless energy transfer, receive, from the second network node, a request for wireless energy transfer, and transmit, to the second network node, energy for one or more components of the second network node after receiving the request for wireless energy transfer.

In an additional aspect of the disclosure, a first network node includes means for transmitting, by the first network node to a second network node, an indication that the first network node supports wireless energy transfer, means for receiving, by the first network node from the second network node, a request for wireless energy transfer, and means for transmitting, by the first network node to the second network node, energy for one or more components of the second network node after transmitting the request for wireless energy transfer.

In an additional aspect of the disclosure, a non-transitory computer-readable medium stores instructions that, when executed by a processor, cause the processor to perform operations. The operations include transmitting, by a first network node to a second network node, an indication that the first network node supports wireless energy transfer, receiving, by the first network node from the second network node, a request for wireless energy transfer, and transmitting, by the first network node to the second network node, energy for one or more components of the second network node after transmitting the request for wireless energy transfer.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram of an example network node capable of receiving wireless energy transfer according to one or more aspects.

FIG. 4 is a block diagram illustrating an example wireless communication system that supports a wireless energy transfer service according to one or more aspects.

FIG. 5 is a block diagram of a plurality of channels for a wireless energy transfer service according to one or more aspects.

FIG. 6 is a block diagram of wireless energy transfer training signals across a plurality of channels and antennas according to one or more aspects.

FIG. 7 is a flow diagram illustrating an example process that supports a wireless energy transfer service according to one or more aspects.

FIG. 8 is a flow diagram illustrating an example process that supports a wireless energy transfer service according to one or more aspects.

FIG. 9 is a flow diagram illustrating an example process that supports a wireless energy transfer service according to one or more aspects.

FIG. 10 is a flow diagram illustrating an example process that supports a wireless energy transfer service according to one or more aspects.

FIG. 11 is a block diagram of an example energy transmitter that supports a wireless energy transfer service according to one or more aspects.

FIG. 12 is a block diagram of an example energy receiver that supports a wireless energy transfer service according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), 6G networks, as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHZ-7.125 GHZ) and FR2 (24.25 GHZ-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHZ-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHZ FDD or TDD implementations, subcarrier spacing may occur with 15 kHz, for example over 1, 5, 10, 20 MHZ, and the like bandwidth. For other various outdoor and small cell coverage deployments of TDD greater than 3 GHZ, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

The scalable numerology of 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

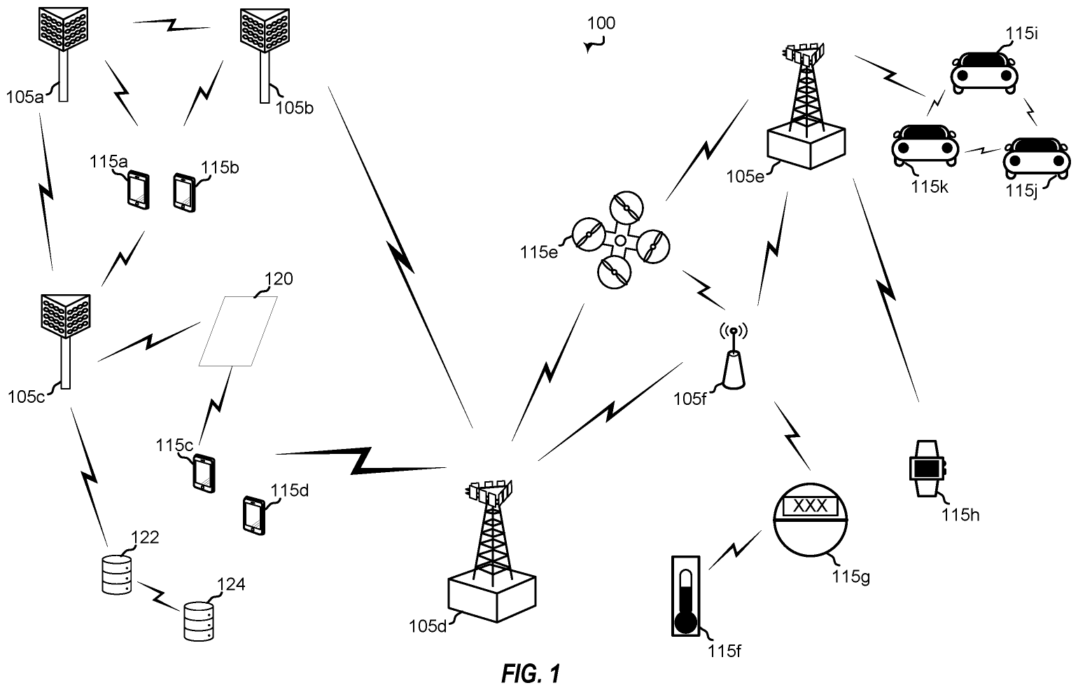

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (cMTC), narrowband IoT (NB-IOT) and the like. UEs 115c-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105c.

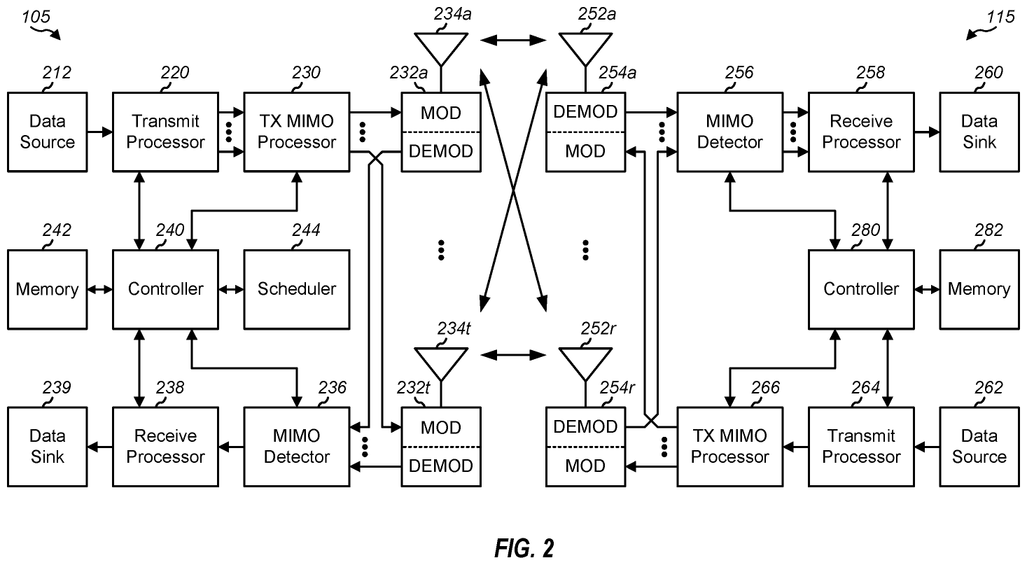

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

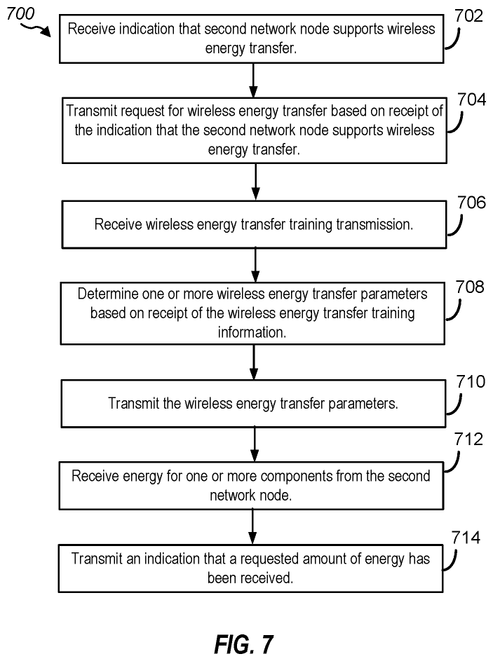

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 7-10, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (cNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

Wireless communication networks, such as wireless network 100 of FIG. 1 or other 5G, 6G, or other wireless communication networks, may support a wireless energy transfer service to transfer energy from one or more energy transmitters, such as base stations, to one or more energy receivers, such as UEs. For example, a wireless energy transfer service may allow an energy receiver to receive indications of support of wireless energy transfer from one or more energy transmitters, transmit a request for energy transfer to one or more energy transmitters, engage in a training procedure to facilitate efficient transfer of wireless energy, and receive energy transferred from one or more energy transmitters. Such operation may allow energy receivers to operate one or more components using energy transmitted by energy transmitters over a wireless network and may allow energy receivers to store energy in one or more energy storage components, such as batteries or capacitors, for future usage. Such energy transfer capabilities may be particularly useful in embodiments where energy receivers include radio frequency identification (RFID) devices, such as IoT devices, with limited or no internal power storage capacity. For example, energy transfer over a wireless network may allow UEs including RFID tags, such as IoT devices or other UEs, to be designed with little or no internal power storage capacity which may reduce a cost of the UEs, allow UEs to be produced with smaller form factors, and allow UEs to continue to operate even when internal power storage is depleted.

Wireless network 100 of FIG. 1 may support a wireless energy transfer service for transmission of energy to one or more UEs, such as cell phones, IoT or IoE devices, or other UEs. For example, in addition to or in place of being a macro base station, base station 105d may be a sub-6 GHz gNB. Furthermore, in addition to or in place of being macro base stations enabled with one of 3 dimension (3D), full dimension (FD), or massive MIMO, base stations 105a-c may be mmWave enabled gNBs providing a mmWave backhaul. Base stations 105a-c may also function as RUs in a RAN context and may communicate with a DU 122 and a CU 124, either wirelessly or through a wired connection. Base stations 105a-c and 105d may communicate with base station 105f which may, in addition to or in place of being a small cell base station, be a smart repeater and may provide side control information for efficient network operation. For example, the base station 105f may be provided with time division duplex (TDD) information, on-off information, and spatial information to enhance coverage of the network. Use of such repeaters may provide enhanced coverage and signal to interference and noise ratio (SINR) operation through smart control of repeating of signals from base stations 105a-d. Reflector 120 may, for example, be a passive reflector, for extending a range of base station 105c. For example, reflector 120 may reflect signals from base station 105c and UE 115c. Base stations 105a-d and f may communicate with UEs 115a-k and may perform wireless power transfer to such UEs 115a-k.

Some network nodes, such as UEs, may include radio frequency energy harvesting circuitry, such as RFID circuitry, for harvesting of wireless energy over the air such as through transmission from one or more energy transmitters, such as one or more base stations. Energy transmitters and receivers may also be referred to as network nodes. Wireless energy transmission signals in such applications may be backscatter modulated. As one particular example, RFID technology is rapidly growing in use, with applications in inventory/asset management inside and outside warehouses, IoT, sustainable sensor networks for factories and/or agriculture, and smart homes. RFID circuitry may, in some embodiments, be operated without battery power at low operational expense, with low maintenance costs, and long device lifetimes.

One particular example of application of a wireless energy transfer service is in passive IoT applications. As 5G and other wireless network embodiments, such as 6G, expand to applications beyond enhanced mobile broadband (cMBB), such as ultra-reliable low latency communications (URLLC) and machine type communication (MTC), wireless networks may include enhanced functionality to support passive IoT functions for applications in asset management, logistics, warehousing, manufacturing, and beyond. For example, in some passive IoT embodiments, a base station, such as a gNB, may read and write information stored on passive IoT devices and provide energy to passive IoT devices. In some cases, reflectors may be used to extend the reach of base stations, allowing information-bearing signals for transmission to and reception from passive IoT devices to be reflected to and from a base station.

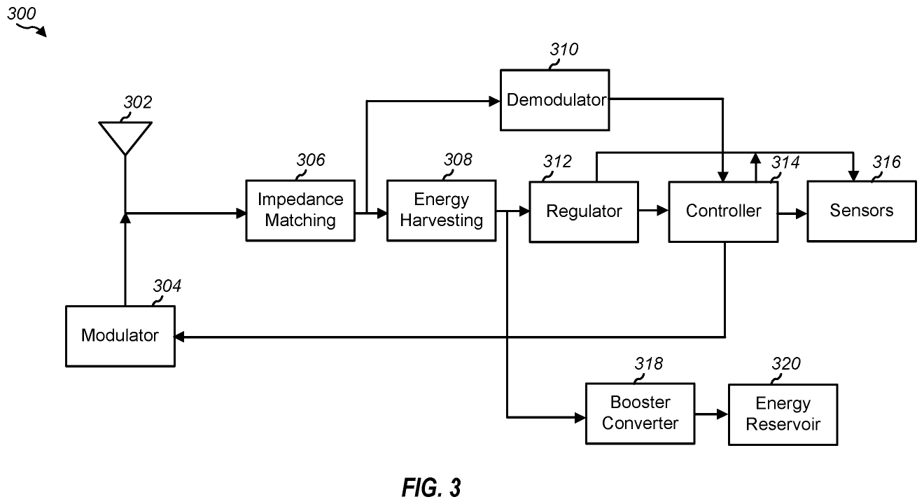

Network nodes that transmit energy through the wireless energy transfer service, such as base stations, may be referred to as energy transmitters, and network nodes that receive energy through the wireless energy transfer service, such as UEs, may be referred to as energy receivers. UEs including RFID energy harvesting circuitry are one example of energy receivers. An example energy receiver 300 is shown in FIG. 3. The features shown in FIG. 3 may be integrated in a UE, such as a UE described with respect to FIGS. 1-2. In some embodiments, energy receivers, such as UEs including RFID circuitry, may include small transponders, referred to as tags, that emit an information-bearing signal upon receiving a signal. Tags may be passive, harvesting energy over the air with no energy storage capacity, semi-passive, harvesting energy over the air with some energy storage capacity, or active, able to harvest energy over the air with substantial energy storage capacity. For example, active tags may include transceiver functionality with ability to engage in conventional signal transmission and reception activities and to operate in ultra-high-frequency ranges, such as 902-928 MHZ, and microwave frequency ranges, such as 2400-2483.5 MHz and 5725-5850 MHZ. Active tags may also include battery or capacitance energy storage to increase reliability of communication and sensitivity of the energy harvesting circuitry. In some cases, active tags may be connected to other external power sources. Semi-passive tags may include battery or capacitance energy storage but may include transponder functionality, rather than full transceiver functionality, and may communicate using backscatter channels at ultra-high frequency ranges, such as 902-928 MHZ, and microwave frequency ranges, such as 2400-2483.5 MHz and 5725-5850 MHz. Semi-passive tags may also have inductive coupling capabilities for charging at high frequencies, such as 13.56 MHz and low frequencies, such as 125 or 134 kHz. Passive tags may not include energy storage capabilities and may otherwise include functionality similar to semi-passive tags. Furthermore, passive tags may include surface acoustic wave functionality at microwave frequencies, such as 2400-2483.5 MHZ. One particular example implementation of passive tags is inclusion of such tags in passive IoT devices.

An energy receiver 300, as shown in FIG. 3, may receive energy transmitted over a wireless network, such as a 5G or 6G wireless network, by an energy transmitter. The energy receiver 300 may include an antenna 302 for receiving signals, such as energy transfer signals or signaling related to energy transfer. The energy receiver 300 may include an impedance matching module 306 for performing impedance matching based on received energy signals. The demodulator 310 may demodulate one or more signals received by the energy receiver 300. Energy harvesting circuit 308 may, for example, include one or more diodes or rectifiers for converting energy received via antenna 302 for use by the energy receiver 300. The regulator 312 may regulate received energy converted by the energy harvesting circuit 308 to provide a regulated voltage and current to power the controller 314. The regulated energy may be used to power controller 314, which may interpret demodulated signals received from the demodulator 310 and may control one or more sensors 316 and other components of the energy receiver 300. For example, the energy receiver 300 may be or may be included in a wireless sensing UE including one or more passive sensors 316. The controller 314 may further control modulator 304 to modulate signals for transmission via antenna 302 to the energy transmitter, such as to a base station. Such signals may, for example, include sensor data from sensors 316. The signals transmitted by the antenna 302 may, for example, be backscatter modulated information signals. Energy output from the energy harvesting circuit 308 may further be stored by the energy receiver 300, if the energy receiver 300 is a semi-passive or active RF tag. For example, booster converter 318 may boost and convert a voltage output from energy harvesting circuit 308 for storage at energy reservoir 320. Energy reservoir 320 may, for example, include one or more capacitors, one or more batteries, or other energy storage components. The energy reservoir 320 may, when energy is stored, be used to power the controller 314, sensors 316, and other components of the energy receiver 300.

Power output by energy harvesting circuit 308 may, for example, be non-linear with power input to the energy harvesting circuit 308 due to diodes included in the energy harvesting circuitry. For example, input power to the energy harvesting circuit 308 may be larger than −20 dBM, such as −10 dBm, to activate the energy harvesting circuit 308, such as to overcome a sensitivity voltage of one or more diodes of the energy harvesting circuit 308. The energy harvesting module 308 may operate with greater efficiency at lower frequencies of power transmission and reception, due to diode junction capacitance and resistance of one or more diodes included in the energy harvesting circuit 308. For example, the energy harvesting circuit 308 may have a frequency-selective conversion efficiency.

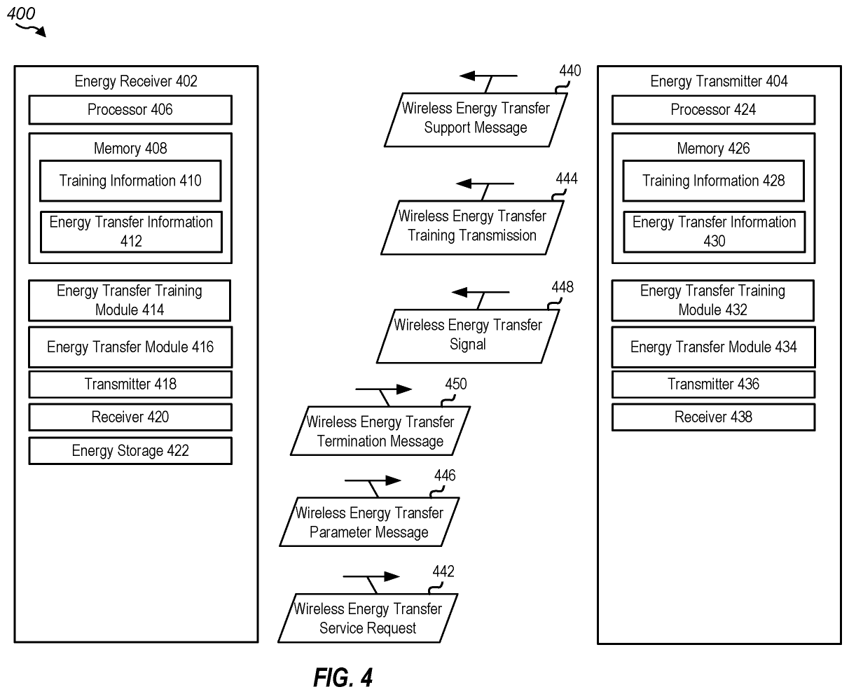

FIG. 4 is a block diagram of an example wireless communications system 400 that supports a wireless energy transfer service according to one or more aspects. In some examples, wireless communications system 400 may implement aspects of wireless network 100. Wireless communications system 400 includes energy receiver 402 and energy transmitter 404. Energy receiver 402 may, for example be a UE, such as a passive device, a semi-passive device including energy storage, a device with a rechargeable battery, or other UE. As one particular example, energy receiver 402 may be a passive IoT device. Energy transmitter 404 may, for example, be a base station, a gNB, an integrated access and backhaul (IAB) node, a repeater, such as a smart repeater, or an energy emitter. UE 115 may be an example of energy receiver 402, and base station 105 may be an example of energy transmitter 404. Although one energy receiver 402 and one energy transmitter 404 are illustrated, in some other implementations, wireless communications system 400 may generally include multiple energy receivers 402, and may include more than one energy transmitter 404. In some implementations, ambient harvesting of RF energy may be infeasible for energy receiver 402 due to lack of power density when the energy receiver is not in close proximity to the energy transmitter 404. Thus, a wireless energy transfer service may facilitate transfer of energy from one or more energy transmitters 404 to one or more energy receivers 402.

Energy receiver 402 may include a variety of components (such as structural, hardware components) used for carrying out one or more functions described herein. For example, these components may include one or more processors 406 (hereinafter referred to collectively as “processor 406”), one or more memory devices 408 (hereinafter referred to collectively as “memory 408”), one or more transmitters 418 (hereinafter referred to collectively as “transmitter 418”), and one or more receivers 420 (hereinafter referred to collectively as “receiver 420”). Processor 406 may be configured to execute instructions stored in memory 408 to perform the operations described herein. In some implementations, processor 406 includes or corresponds to one or more of receive processor 258, transmit processor 264, and controller 280, and memory 408 includes or corresponds to memory 282.

Memory 408 includes or is configured to store training information 410 and energy transfer information 412. Training information 410 may, for example, include wireless energy transfer training information received from energy transmitter 404, such as one or more training parameters, or measurements performed on one or more energy signals received from the energy transmitter 404. Training parameters may, for example, include a length of a training session between the energy receiver 402 and the energy transmitter 404, feedback resources for transmission of training feedback, such as wireless energy transfer parameters determined based on receipt of wireless energy transfer training information, information regarding one or more bands for transmission of energy training signals, information regarding one or more channels of one or more bands for transmission of energy training signals, information regarding one or more antennas the energy transmitter 404 will use for transmission of energy training signals, or information regarding one or more beamforming, precoding, or optimized waveform, such as continuous waveform or multi-sine waveform, parameters that the energy transmitter 404 will use for transmission of energy training signals. Energy transfer information 412 may include, for example, energy transfer parameters determined by the energy receiver 402 based on receipt of wireless energy transmission training signals from the energy transmitter 404 during a training session. For example, the energy receiver 402 may perform one or more measurements on wireless energy transmission training signals transmitted by the energy transmitter 404 during a training session and store the measurements as energy transfer information 412. In some embodiments, energy transfer information 412 may include information indicating one or more channels, bands, beam-forming parameters, precoding parameters, or optimized waveform parameters that may be used in transmitting energy from the energy transmitter 404 to the energy receiver 402. For example, channels, bands, beamforming parameters, or optimized waveform parameters of the energy transfer information 412 may be determined based on measurements performed by the energy receiver 402 on one or more wireless energy transmission training signals during a training session. In some embodiments, energy transfer information 412 may include an identifier of the energy receiver 402, one or more parameters of energy harvesting circuitry of the energy receiver 402, such as information indicating one or more frequency bands, waveform configurations, beam-forming configurations, or precoding configurations in which the energy harvesting circuitry may function with greater efficiency, one or more input powers at which energy harvesting circuitry of the energy receiver 402 may operate with greater efficiency, an amount of energy to be requested by the energy receiver 402, such as an amount of energy required to power one or more components of the energy receiver 402 or an amount of energy required to fully or partially charge an energy storage component 422 of the energy receiver 402, a time duration to be requested for a wireless energy transfer session from an energy transmitter 404, an amount of energy to be requested from an energy transmitter 404, such as a coarse amount of wireless energy to be requested, e.g., 5 mJ or 100 mJ, or other energy transfer information 412.

Transmitter 418 is configured to transmit reference signals, control information and data to one or more other devices, and receiver 420 is configured to receive references signals, synchronization signals, control information and data from one or more other devices. For example, transmitter 418 may transmit signaling, control information and data to, and receiver 420 may receive signaling, control information and data from, energy transmitter 404. In some implementations, transmitter 418 and receiver 420 may be integrated in one or more transceivers. Transmitter 418 and receiver 420 may, alternatively, be integrated into a single transponder. Transmitter 418 and receiver 420 may communicate with energy transmitter 404 using backscatter modulation. Additionally or alternatively, transmitter 418 or receiver 420 may include or correspond to one or more components of UE 115 described with reference to FIG. 2.

Energy transfer training module 414 may include instructions or logic for engaging in an energy transfer training procedure with energy transmitter 404. For example, when wireless energy transfer is requested by energy receiver 402, energy transmitter 404 may transmit one or more wireless energy transfer signals, such as wireless energy transfer training signals, and energy transfer training module 414 may include instructions for performing one or more measurements on the one or more wireless energy transfer signals and for determining wireless energy transfer parameters based on the signals for transmission to energy transmitter 404. Energy transfer module 416 may include instructions or logic for engaging in a wireless energy transfer session with energy transmitter 404. Energy storage 422 may include one or more batteries or capacitors for storing energy received from energy transmitter 404.

Energy transmitter 404 may include a variety of components (such as structural, hardware components) used for carrying out one or more functions described herein. For example, these components may include one or more processors 424 (hereinafter referred to collectively as “processor 424”), one or more memory devices 426 (hereinafter referred to collectively as “memory 426”), one or more transmitters 436 (hereinafter referred to collectively as “transmitter 436”), and one or more receivers 438 (hereinafter referred to collectively as “receiver 438”). Processor 424 may be configured to execute instructions stored in memory 426 to perform the operations described herein. In some implementations, processor 424 includes or corresponds to one or more of receive processor 238, transmit processor 220, and controller 240, and memory 426 includes or corresponds to memory 242.

Memory 426 includes or is configured to store training information 428 and energy transfer information 430. Training information 428 may, for example, include wireless energy transfer training information to be transmitted to energy receiver 402, such as one or more training parameters or measurements performed on one or more energy signals transmitted by energy transmitter 402 to the energy transmitter 404. Training parameters may, for example, include a length of a training session between the energy receiver 402 and the energy transmitter 404, feedback resources for transmission of training feedback, such as wireless energy transfer parameters determined based on receipt of wireless energy transfer training information, information regarding one or more bands for transmission of energy training signals, information regarding one or more channels of the one or more bands for transmission of energy training signals, information regarding one or more antennas the energy transmitter 404 will use for transmission of energy training signals, information regarding one or more beamforming, precoding, or optimized waveform, such as continuous waveform or multi-sine waveform, parameters that the energy transmitter 404 will use for transmission of energy training signals. Energy transfer information 430 may include, for example, energy transfer parameters determined by the energy receiver 402 based on receipt of wireless energy transmission training signals from the energy transmitter 404 during a training session. For example, the energy receiver 402 may perform one or more measurements on wireless energy transmission training signals transmitted by the energy transmitter 404 during a training session and may transmit the measurements to the energy transmitter 404 to be stored as energy transfer information 430. In some embodiments, energy transfer information 430 may include information indicating one or more channels, bands, beam-forming parameters, precoding parameters, or optimized waveform parameters that may be used in transmitting energy from the energy transmitter 404 to the energy receiver 402. For example, channels, bands, beamforming parameters, or optimized waveform parameters of the energy transfer information 412 may be determined by an energy receiver 402 based on measurements performed by the energy receiver 402 on one or more wireless energy transmission training signals during a training session and may be transmitted to the energy transmitter 404. In some embodiments, energy transfer information 430 may include an identifier of the energy receiver 402, one or more parameters of energy harvesting circuitry of the energy receiver 402, such as information indicating one or more frequency bands, waveform configurations, beam-forming configurations, or precoding configurations in which the energy harvesting circuitry may function with greater efficiency, one or more input powers at which energy harvesting circuitry of the energy receiver 402 may operate with greater efficiency, an amount of energy requested by the energy receiver 402, such as an amount of energy required to power one or more components of the energy receiver 402 or an amount of energy required to fully or partially charge an energy storage component 422 of the energy receiver 402, a time duration requested for a wireless energy transfer session from an energy transmitter 404, an amount of energy requested from the energy transmitter 404, such as a coarse amount of wireless energy transfer energy requested, e.g., 5 mJ or 100 mJ, or other energy transfer information 430.

Transmitter 436 is configured to transmit reference signals, synchronization signals, control information and data to one or more other devices, and receiver 438 is configured to receive reference signals, control information and data from one or more other devices. For example, transmitter 436 may transmit signaling, control information and data to, and receiver 438 may receive signaling, control information and data from, energy receiver 402. In some implementations, transmitter 436 and receiver 438 may be integrated in one or more transceivers. Transmitter 436 and receiver 438 may communicate with energy receiver 402 using backscatter modulation. Additionally or alternatively, transmitter 436 or receiver 438 may include or correspond to one or more components of base station 105 described with reference to FIG. 2.

Energy transfer training module 432 may include instructions or logic for engaging in an energy transfer training procedure with energy receiver 402. For example, when wireless energy transfer is requested by energy receiver 402, energy transmitter 404 may transmit one or more wireless energy transfer signals, such as wireless energy transfer training signals, and energy transfer training module 432 may include instructions for transmitting such signals. Energy transfer module 434 may include instructions or logic for engaging in a wireless energy transfer session with energy receiver 402.

In some implementations, wireless communications system 400 implements a 5G NR network, a 6G network, or other wireless network. For example, wireless communications system 400 may include multiple 5G-capable UEs 115, or energy receivers, and multiple 5G-capable base stations 105, or energy transmitters, such as UEs and base stations configured to operate in accordance with a 5G NR network protocol such as that defined by the 3GPP.

During operation of wireless communications system 400, energy transmitter 404 may transmit a wireless energy transfer support message 440. The wireless energy transfer support message 440 may include energy transfer information 430. The energy receiver 402 may receive the wireless energy transfer support message 440 and may transmit a wireless energy transfer service request 442. For example, if the energy receiver requires wireless energy, the energy receiver may respond to the wireless energy transfer support message 440 with a wireless energy transfer service request 442. Such a request may include an identifier of the energy receiver 402, information indicating parameters of an energy harvesting circuit of the energy receiver 402, information indicating an amount of requested energy, information indicating a time period requested for the energy transfer, or other information.

In some embodiments, when the energy transmitter 404 receives the wireless energy transfer service request 442, the energy transmitter 404 may transmit wireless energy transfer training transmission 444. In some embodiments, the wireless energy transfer training transmission 444 may include training information 428, such as an indication of a length of the training session or feedback resources for the energy receiver 402 to use in feeding back results of the training session to the energy transmitter 404. In some embodiments, the wireless energy transfer training transmission 444 may include one or more wireless energy transfer signals, such as wireless energy transfer training signals, on one or more frequency bands or channels. In some embodiments, transmitting the wireless energy transfer training transmission 444 may include transmitting wireless energy transfer training signals using multiple different antennas, beam-forming parameters, precoding parameters, or optimized waveform parameters. In some embodiments, training information 428 may be transmitted in the wireless energy transfer training transmission 444 before transmission of one or more wireless energy transfer training signals. The energy receiver 402 may receive the wireless energy transfer training transmission 444 and may perform one or more measurements on one or more wireless energy transfer training signals of the wireless energy transfer training transmission. The energy receiver 402 may transmit a wireless energy transfer parameter message 446 when the training session has ended. The wireless energy transfer parameter message 446 may, for example, include energy transfer information 412 and/or training information 410, such as an indication of channels, bands, antennas, beam-forming parameters, precoding parameters, optimized waveform parameters, or other parameters, determined based on the wireless energy transfer training transmission 444, for use by the energy transmitter 404 in the wireless energy transmission to the energy receiver 404.

The energy transmitter 404 may then transmit a wireless energy transfer signal 448 to transmit energy to the energy receiver 402. The energy receiver 402 may receive the wireless energy transfer signal 448 and may use energy of the wireless energy transfer signal 448 to charge the energy storage 422 and/or to power one or more components of the energy receiver 402. The wireless energy transfer signal 448 may be transmitted on one or more channels or frequency bands. When the energy receiver 402 has received sufficient energy, such as a sufficient amount of energy to power one or more components to perform a desired task or to charge an energy storage 422, the energy receiver 402 may transmit a wireless energy transfer termination message 450 to terminate energy transmission from the energy transmitter 404 to the energy receiver 402. Upon receipt of the wireless energy transfer termination message 450, the energy transmitter 404 may cease transmission of the wireless energy transfer signal 448. Thus, the energy transmitter 404 may transmit energy over a wireless network to power one or more components of the energy receiver 402.

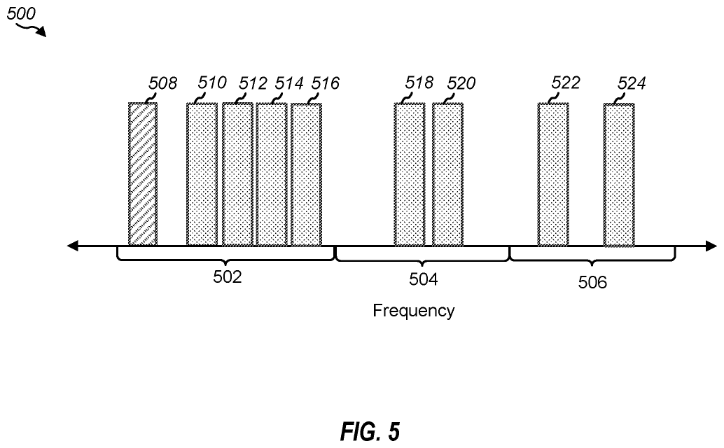

Multiple channels of a network may be reserved for communication related to a wireless energy transfer service and for transmission of wireless energy signals. An example frequency plot 500 of a plurality of channels for a wireless energy transfer service is shown in FIG. 5. In some embodiments, a first channel 508 of a first band 502 may be reserved for communications related to the wireless energy transfer service, such as for transmission of indications of wireless energy transfer support, requests for wireless energy transfer, and other indications. In some embodiments, a such communications may be transmitted using legacy channels such as a physical broadcast channel (PBCH), a master information block (MIB) or system information block (SIB). In some embodiments, the first channel 508 may be reserved for an energy transmitter to broadcast an indication that the energy transmitter supports wireless energy transfer and for one or more energy receivers to provide feedback, such as indications of parameters for wireless energy transfer determined based on a wireless energy transfer training session, and requests for wireless energy transfer. In some embodiments, multiple channels 510-524 of multiple frequency bands 502-506, may be reserved for transmission of energy, such as for transmission of energy transfer signals. For example, a broadcast message on the first channel 508 may indicate the number of channels 510-524 for wireless energy transfer and respective frequency bands 502-506 of each of the channels. Such frequency bands may, for example, be 900 MHZ, 2.4 GHZ, and other frequency bands.

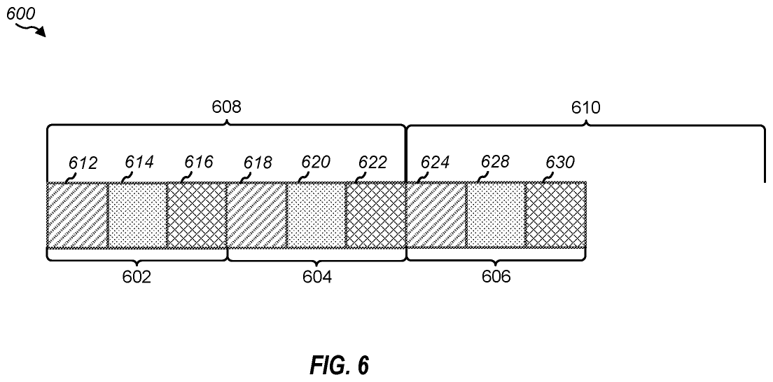

In a wireless energy transfer training session, an energy transmitter may transmit energy transfer signals on one or more channels of one or more bands to allow for determination of preferred parameters for energy transfer in the energy transfer session. An example transmission plot 600 for a wireless energy transfer training session is shown in FIG. 6. As one example, an energy transmitter may transmit energy transfer signals, such as energy transfer training signals 612-630, using multiple antennas such as a first antenna 608 and a second antenna 610, to an energy receiver. Such signals 612-630 may be transmitted on a plurality of channels, such as a first channel 602, a second channel 604, and a third channel 606. Such signals 612-630 may also be transmitted using different precoding parameters, different beam-forming parameters, or different optimized waveform parameters. For example, a first signal 612 using a first precoding, beam-forming, and optimized waveform configuration may be transmitted on a first channel 602 using a first antenna 608, a second signal 618 using the same configuration maybe transmitted on a second channel 604 using the first antenna 608, and a third signal 624 may be transmitted on a third channel 606 using a second antenna 610 using the same configuration. Likewise, a fourth signal 614 using a second precoding, beam-forming, and optimized waveform configuration may be transmitted on a first channel 602 using a first antenna 608, a fifth signal 620 using the same configuration maybe transmitted on a second channel 604 using the first antenna 608, and a sixth signal 628 may be transmitted using the same configuration on a third channel 606 using a second antenna 610. Additionally, a seventh signal 616 using a third precoding, beam-forming, and optimized waveform configuration may be transmitted on a first channel 602 using a first antenna 608, a eighth signal 622 using the same configuration maybe transmitted on a second channel 604 using the first antenna 608, and a ninth signal 630 may be transmitted on a third channel 606 using a second antenna 610 using the same configuration. Although nine signals with three different configurations on three channels using two antennas are shown in FIG. 6, fewer or greater signals using fewer or greater configurations transmitted on fewer or greater channels and antennas may be used for a wireless energy transfer training session.

FIG. 7 is a flow diagram illustrating an example process 700 that supports a wireless energy transfer service according to one or more aspects. Operations of process 700 may be performed by a network node, such as an energy receiver. For example, operations of process 700 may be performed by UE 115 described above with reference to FIGS. 1 and 2 or an energy receiver, as described with reference to FIGS. 3-4, 12. For example, operations (also referred to as “blocks”) of process 700 may enable UE 115 to support a wireless energy transfer service.

At block 702, a first network node may receive an indication that a second network node supports a wireless energy transfer service. The first network node may, for example, be an energy receiver, such as a UE, and the second network node may, for example, be an energy transmitter, such as a base station. The indication that the second network node supports a wireless energy transfer service may, for example, be received in a backscatter modulation transmission and/or broadcast on a channel reserved for communication related to a wireless energy transfer service. For example, the indication may be broadcast on a legacy channel, such as a PBCH, a MIB, or a SIB. The indication may include an indication of a maximum deliverable energy supported by the second network node, an indication of a transmit energy of the second network node, an indication of one or more frequency bands for wireless energy transfer supported by the second network node, such as a 900 MHz frequency band, a 2.4 GHz frequency band, or other frequency band, and/or an indication of one or more channels for wireless energy transfer supported by the second network node. For example, the indication may include an indication of a number of channels reserved for wireless energy transfer in a particular band. In some embodiments, the indication may include an identifier of the second network node and/or an identifier of a service associated with the second network node, such as a vendor associated with the second network node. The identifier of the second network node and/or the identifier of the service associated with the second network node may be used for security and/or payment related procedures similar to operation of a public land mobile network (PLMN). In some embodiments, the indication may include an indication that the second network node serves only certain energy receivers and/or prioritizes certain energy receivers over other energy receivers. In some embodiments, energy signals may be broadcast by the second network node and received by the first network node prior to transmission of the indication to provide power to the first network node for receipt and decoding or processing of the indication.

At block 704, the first network node may transmit a request for wireless energy transfer based on receipt of the indication that the second network node supports wireless energy transfer. Such a request may include preferred service parameters of the first network node. For example, such a request may include an indication of an identifier of the first network node, an indication of an amount of requested energy, an indication of a time duration of a requested energy transfer, and/or an indication of an energy storage capacity of the first network node. An indication of an identifier of the first network node may, for example, be used for payment and/or for PLMN selection. The request may also include information regarding an energy harvesting circuit of the first network node, such as an identifier of the energy harvesting circuit or an indication of preferred service parameters, such as a preferred carrier frequency or band or a preferred waveform configuration, associated with the energy harvesting circuit. For example, some energy harvesting circuits may operate with greater efficiency when energy is transmitted in a 900 MHz or 2.4 GHz frequency band or using a multi-sine or continuous waveform configuration. Likewise, some energy harvesting circuits may operate with greater efficiency at certain input powers, such as 0 dBm or 5 dBm. Such parameters may be indicated to a second network node in a request for wireless energy. In some embodiments, a second network node may estimate an input power for greatest efficiency at the second network node by performing one or more RSSI or reference signal received power (RSRP) measurements on the transmitted request for wireless energy transfer and may determine a power for transmission of wireless energy to the first network node based on such measurements, such as through performing a coarse power estimation. In some embodiments, the request may include an indication of a coarse amount of requested wireless energy transfer, such as 5 mJ or 100 mJ. Such amounts may vary based on a storage capacity of the first network node, a state of charge of one or more energy storage components of the first network node, and/or an amount of energy required to power the first network node. The second network node may estimate a duration of a service based on an amount of requested wireless energy. Thus, the request for wireless energy transfer may be transmitted in response to receipt of an indication that a second network node supports wireless energy transfer and may include one or more parameters for use by a second network node in transmitting wireless energy to the first network node.

At block 706, the first network node may receive a wireless energy transfer training transmission from the second network node. The wireless energy transfer training transmission may, for example, include an indication of one or more training parameters and/or one or more energy transmission signals. For example, upon receipt of a request for wireless energy transfer, a second network node may initiate a wireless energy transfer training session, which may be similar to an RRC link establishment procedure. The one or more training parameters may, for example, include an indication of a length of a training session and/or an indication of one or more feedback resources of the training session, for use by the first network node in providing feedback based on training signals received from the second network node. The one or more energy transmission signals may, for example, be one or more energy transmission signals transmitted using supported parameters for transmission during a wireless energy transmission session. For example, the first network node may receive energy signals transmitted using different channels in one or more bands, such as one or more preferred bands. The first network node may receive energy signals transmitted using different antennas. The first network node may receive energy signals transmitted using different beam-forming, precoding, or optimized waveform parameters, such as energy signals transmitted using a continuous waveform and/or a multi-sine waveform. Thus, multiple energy transmission signals may be received by the first network node at block 706 for measurement by the first network node.

At block 708, the first network node may determine one or more wireless energy transfer parameters based on receipt of the wireless energy transfer training transmission. For example, the first network node may perform one or more measurements on received energy transmission signals to determine an energy transmission signal with preferred characteristics, such as an energy transmission signal that will provide energy to the first network node with the greatest efficiency. Such parameters may, for example, include a determined channel or band for energy transmission, a determined antenna of the second network node for energy transmission, determined beam-forming, precoding, or optimized waveform parameters for energy transmission, or other determined parameters.

At block 710, the first network node may transmit the determined wireless energy transfer parameters to the second network node. For example, the first network node may transmit an indication of a determined channel, frequency band, antenna, beam-forming configuration, precoding configuration, optimized waveform configuration, or other configuration for transmission of power to the first network node. Such parameters may, for example, be transmitted using the feedback resources indicated in the wireless energy transfer training transmission at block 706.

At block 712, the first network node may receive energy for one or more components from the second network node. For example, the first network node may receive one or more energy transmission signals from the second network node. The one or more energy transmission signals may be transmitted in one or more frequency bands, on one or more channels, using one or more antennas, and using one or more beam-forming, precoding, or optimized waveform configurations. In particular, one or more antennas of the first network node may receive transmitted energy from a second network node and an energy harvesting circuit of the first network node may convert the energy for use by components of the first network node or for storage by one or more energy storage components of the first network node.

At block 714, the first network node may transmit an indication that a requested amount of energy has been received. For example, once the first network node determines that an amount of energy has been received, such as an amount of energy required to power the first network node and/or an amount of energy required to charge an energy storage component of the first network node to a desired level, the first network node may transmit such an indication to the second network node to instruct the second network node to end the energy transfer session. In some embodiments, the indication may comprise an acknowledgement that a requested amount of energy has been received and may also include a passcode to facilitate charging by the second network node for the wireless energy transfer service. For example, termination of an energy transfer session may function similarly to an RRC link disconnect procedure. Thus, energy may be received from a second network node by a first network node over a wireless network and used to power one or more components of the first network node.

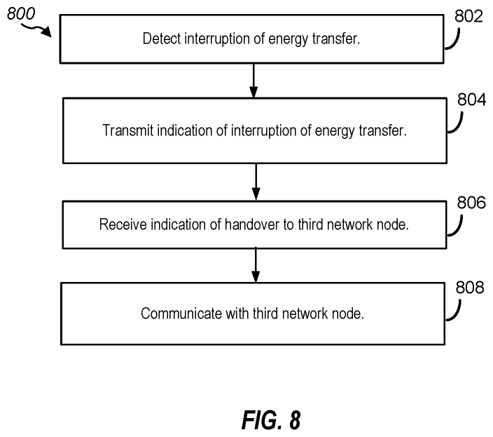

FIG. 8 is a flow diagram illustrating an example process 800 that supports a wireless energy transfer service according to one or more aspects. Operations of process 800 may be performed by a network node, such as an energy receiver. For example, operations of process 800 may be performed by UE 115 described above with reference to FIGS. 1 and 2, an energy receiver, as described with reference to FIGS. 3-4, 12. For example, operations (also referred to as “blocks”) of process 800 may enable UE 115 to support a wireless energy transfer service.

In some embodiments, an energy transmitter may not be able to fulfil an energy transfer request by an energy receiver and/or an energy transfer session may be interrupted. For example, at block 802, a first network node may detect an interruption of an energy transfer. Such an interruption may, for example, be caused by movement of the first network node and/or environmental conditions between the first network node and the second network node. For example, the method 800 may, in some embodiments, be performed between blocks 712 and 714 of FIG. 7

At block 804, the first network node may transmit an indication of interruption of energy transfer to the second network node. Such an indication may, for example, include a request for a new wireless energy transfer session establishment and/or a new wireless energy transfer training session. In some embodiments, the method may proceed from block 804 to blocks 706-714 of FIG. 7, such as when a wireless energy transmitter determines that it can fulfill the request for a new wireless energy transfer session.

However, if the second network node determines that it is unable to fulfill a request for a new wireless energy transfer session, the second network node may transmit, and the first network node may receive, at block 806, an indication of a handover. The handover indication may include an identifier of a third network node, such as a second energy transmitter, and information regarding one or more channels and/or frequency bands on which the first network node may communicate with the third network node. At block 808, the first network node may communicate with the third network node, such as performing the method described in one or more blocks of FIG. 7 in communication with the third network node. In some embodiments, blocks 806 and 808 of FIG. 8 may be performed following block 704 of FIG. 7, such as when an energy transmitter determines, following an initial request for wireless energy transfer, that the energy transmitter cannot fulfill the request. Thus, when a network node determines that it cannot fulfill a request for wireless energy transfer, it may handover the wireless energy transfer session to another energy transmitter, and an energy receiver may perform the method 700 described with respect to FIG. 7 in communication with the new energy transmitter.

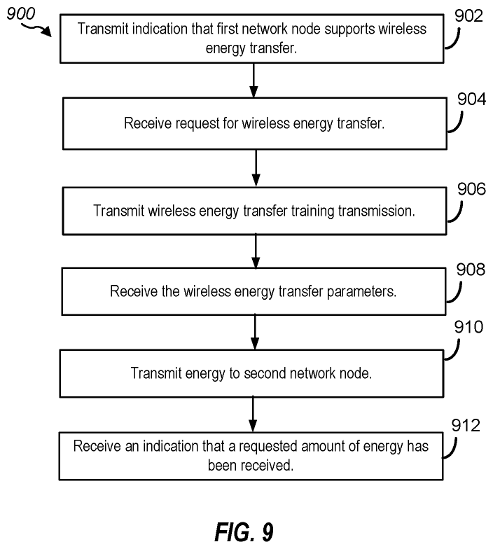

FIG. 9 is a flow diagram illustrating an example process 900 that supports a wireless energy transfer service according to one or more aspects. Operations of process 900 may be performed by a network node, such as an energy transmitter. For example, operations of process 900 may be performed by base station 105 described above with reference to FIGS. 1 and 2, an energy transmitter, as described with reference to FIGS. 3-4, 12. For example, operations (also referred to as “blocks”) of process 900 may enable base station 105 to support a wireless energy transfer service.

At block 902, a first network node may transmit an indication to a second network node that the first network node supports a wireless energy transfer service. The first network node may, for example, be an energy transmitter, such as a base station, and the second network node may, for example, be an energy receiver, such as a UE. The indication that the first network node supports a wireless energy transfer service may, for example, be transmitted in a backscatter modulation transmission and/or broadcast on a channel reserved for communication related to a wireless energy transfer service. For example, the indication may be broadcast on a legacy channel, such as a PBCH, a MIB, or a SIB. The indication may include an indication of a maximum deliverable energy supported by the first network node, an indication of a transmit energy of the first network node, an indication of one or more frequency bands for wireless energy transfer supported by the first network node, such as a 900 MHz frequency band, a 2.4 GHz frequency band, or other frequency band, and/or an indication of one or more channels for wireless energy transfer supported by the first network node. For example, the indication may include an indication of a number of channels reserved for wireless energy transfer in a particular band. In some embodiments, the indication may include an identifier of the first network node and/or an identifier of a service associated with the first network node, such as a vendor associated with the first network node. The identifier of the first network node and/or the identifier of the service associated with the first network node may be used for security and/or payment related procedures similar to operation of a public land mobile network (PLMN). In some embodiments, the indication may include an indication that the first network node serves only certain energy receivers and/or prioritizes certain energy receivers over other energy receivers. In some embodiments, energy signals may be broadcast by the first network node and received by a second network node prior to transmission of the indication to provide power to the second network node for receipt and decoding or processing of the indication.

At block 904, the first network node may receive a request for wireless energy transfer. The request may be transmitted by the second network node based on receipt of the indication that the first network node supports wireless energy transfer. Such a request may include preferred service parameters of the second network node. For example, such a request may include an indication of an identifier of the second network node, an indication of an amount of requested energy, an indication of a time duration of a requested energy transfer, and/or an indication of an energy storage capacity of the second network node. An indication of an identifier of the second network node may, for example, be used for payment and/or for PLMN selection. The request may also include information regarding a energy harvesting circuit of the second network node, such as an identifier of the energy harvesting circuit or an indication of preferred service parameters, such as a preferred carrier frequency or band or a preferred waveform configuration, associated with the energy harvesting circuit. For example, some energy harvesting circuits may operate with greater efficiency when energy is transmitted in a 900 MHZ or 2.4 GHz frequency band or using a multi-sine or continuous waveform configuration. Likewise, some energy harvesting circuits may operate with greater efficiency at certain input powers, such as 0 dBm or 5 dBm. Such parameters may be indicated to the first network node in the received request for wireless energy. In some embodiments, the first network node may estimate an input power for greatest efficiency at the energy receiver by performing one or more RSSI or reference signal received power (RSRP) measurements on the transmitted request for wireless energy transfer and may determine a power for transmission of wireless energy to the first network node based on such measurements, such as through performing a coarse energy estimation. In some embodiments, the message may include an indication of a coarse amount of requested wireless energy transfer, such as 5 mJ or 100 mJ. Such amounts may vary based on a storage capacity of the second network node, a state of charge of one or more energy storage components of the second network node, and/or an amount of energy required to power the second network node. The first network node may estimate a duration of a service based on an amount of requested wireless energy. Thus, the request for wireless energy transfer may be received and may include one or more parameters for use by the first network node in transmitting wireless energy to the second network node.

At block 906, the first network node may transmit wireless energy transfer training transmission to the second network node. The wireless energy transfer training transmission may, for example, include an indication of one or more training parameters and/or one or more energy transmission signals. For example, upon receipt of a request for wireless energy transfer, the first network node may initiate a wireless energy transfer training session, which may be similar to an RRC link establishment procedure. The one or more training parameters may, for example, include an indication of a length of a training session and/or an indication of one or more feedback resources of the training session, for use by the second network node in providing feedback based on training signals received from the first network node. The one or more energy transmission signals may, for example, be one or more energy transmission signals transmitted using supported parameters for transmission during a wireless energy transmission session. For example, the first network node may transmit energy signals using different channels in one or more bands, such as one or more preferred bands. The first network node may transmit energy signals using different antennas. The first network node may transmit energy signals using different beam-forming, precoding, or optimized waveform parameters, such as energy signals transmitted using a continuous waveform and/or a multi-sine waveform. Thus, multiple energy transmission signals may be transmitted by the first network node at block 906 for measurement by the second network node.

At block 908, the first network node may receive wireless energy transfer parameters from the second network node. For example, the first network node may receive an indication of a determined channel, frequency band, antenna, beam-forming configuration, precoding configuration, optimized waveform configuration, or other configuration for transmission of energy to the second network node. Such parameters may, for example, be determined by the second network node based on the wireless energy transfer training transmission transmitted at block 906. Such parameters may, for example, be transmitted and received using the feedback resources indicated in the wireless energy transfer training transmission at block 906.

At block 910, the first network node may transmit energy to the second network node. For example, the first network node may transmit one or more energy transmission signals to the second network node. The one or more energy transmission signals may be transmitted in one or more frequency bands, on one or more channels, using one or more antennas, and using one or more beam-forming, precoding, or optimized waveform configurations. In particular, one or more antennas of the first network node may transmit energy for reception by one or more antennas of the second network node, and an energy harvesting circuit of the second network node may convert the energy for use by components of the second network node or for storage by one or more energy storage components of the second network node.

At block 912, the first network node may receive an indication that a requested amount of energy has been received. For example, once the second network node determines that an amount of energy has been received, such as an amount of energy required to power the second network node and/or an amount of energy required to charge an energy storage component of the second network node to a desired level, the second network node may transmit such an indication to the first network node to instruct the first network node to end the energy transfer session. The first network node may then cease transmission of wireless energy to the second network node. In some embodiments, the indication may comprise an acknowledgement that a requested amount of energy has been received and may also include a passcode to facilitate charging by the first network node for the wireless energy transfer service. Thus, energy may be transmitted by a first network node to a second network node over a wireless network and used to power one or more components of the second network node.

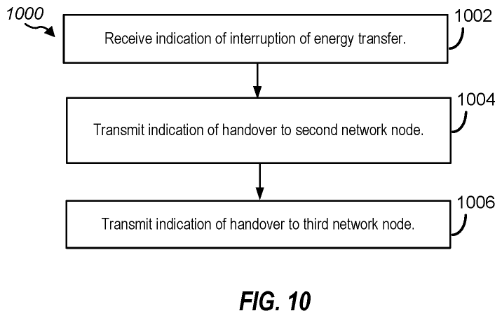

FIG. 10 is a flow diagram illustrating an example process 1000 that supports a wireless energy transfer service according to one or more aspects. Operations of process 1000 may be performed by a network node, such as an energy transmitter. For example, operations of process 1000 may be performed by base station 105 described above with reference to FIGS. 1 and 2 or an energy transmitter, as described with reference to FIGS. 3-4, 12. For example, operations (also referred to as “blocks”) of process 1000 may enable base station 105 to support a wireless energy transfer service.

In some embodiments, an energy transmitter may not be able to fulfill an energy transfer request by an energy receiver and/or an energy transfer session may be interrupted. For example, the method 1000 may, in some embodiments, be performed between blocks 910 and 912 of FIG. 9. At block 1002, a first network node may receive an indication of interruption of energy transfer from a second network node. Such an indication may, for example, include a request for a new wireless energy transfer session establishment and/or a new wireless energy transfer training session. In some embodiments, the method 1000 may proceed from block 1002 to blocks 904-912 of FIG. 9, such as when a wireless energy transmitter determines that it can fulfill the request for a new wireless energy transfer session.

However, if the first network node determines that it is unable to fulfill a request for a new wireless energy transfer session, the first network node may transmit an indication of a handover to the second network node, at block 1004. The handover indication may include an identifier of a third network node, such as a second energy transmitter, and information regarding one or more channels and/or frequency bands on which the first network node may communicate with the third network node. The first network node may then, at block 1006, transmit an indication of the handover to the third network node, to which the wireless energy transfer session is being handed over. The second network node may then communicate with the third network node, such as performing the method described in one or more blocks of FIG. 7 in communication with the third network node. In some embodiments, blocks 1004 and 1006 of FIG. 10 may be performed following block 904 of FIG. 9, such as when the first network node determines, following an initial request for wireless energy transfer, that the first network node cannot fulfill the request. Thus, when a network node determines that it cannot fulfill a request for wireless energy transfer, the network node may handover the wireless energy transfer session to a different network node, and the different network node may perform the method 900 described with respect to FIG. 9 in communication with the second network node.

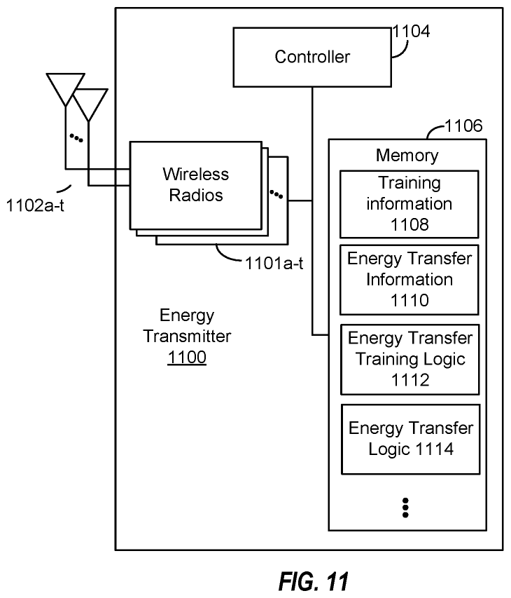

FIG. 11 is a block diagram of an example energy transmitter 1100 that supports a wireless energy transfer service according to one or more aspects. Energy transmitter 1100 may be configured to perform operations, including the blocks of processes 900 and 1000 described with reference to FIGS. 9-10. In some implementations, energy transmitter 1100 includes the structure, hardware, and components shown and described with reference to base station 105 of FIGS. 1-3. For example, energy transmitter 1100 may include controller 1104, which may correspond to controller 240 and which operates to execute logic or computer instructions stored in memory 1106, which may correspond to memory 242, as well as controlling the components of energy transmitter 1100 that provide the features and functionality of energy transmitter 1100. Energy transmitter 1100, under control of controller 1104, transmits and receives signals via wireless radios 1101a-t and antennas 1102a-t. Wireless radios 1101a-t may include various components and hardware, as illustrated in FIG. 2 for base station 105, including modulator and demodulators 232a-t, transmit processor 220, TX MIMO processor 230, MIMO detector 236, and receive processor 238.

As shown, the memory 1106 may include training information 1108, energy transfer information 1110, energy transfer training logic 1112, and energy transfer logic 1114. Training information 1108 may, for example, include wireless energy transfer training information to be transmitted to energy receiver 1200, such as one or more training parameters or measurements performed on one or more energy signals transmitted by energy transmitter 1100 to the energy transmitter 1200. Training parameters may, for example, include a length of a training session between the energy receiver 1200 and the energy transmitter 1100, feedback resources for transmission of training feedback, such as wireless energy transfer parameters determined based on receipt of wireless energy transfer training information, information regarding one or more preferred bands for transmission of energy training signals, information regarding one or more channels of one or more preferred bands for transmission of energy training signals, information regarding one or more antennas the energy transmitter 1100 will use for transmission of energy training signals, information regarding one or more beamforming, precoding, or optimized waveform, such as continuous waveform or multi-sine waveform, parameters that the energy transmitter 1100 will use for transmission of energy training signals. Energy transfer information 1110 may include, for example, energy transfer parameters determined by the energy receiver 1200 based on receipt of wireless energy transmission training signals from the energy transmitter 1100 during a training session. For example, the energy receiver 1200 may perform one or more measurements on wireless energy transmission training signals transmitted by the energy transmitter 1100 during a training session and may transmit the measurements to the energy transmitter 1100 to be stored as energy transfer information 1110. In some embodiments, energy transfer information 1110 may include information indicating one or more channels, bands, beam-forming parameters, precoding parameters, or optimized waveform parameters that may be used in transmitting energy from the energy transmitter 1110 to the energy receiver 1200. In some embodiments, energy transfer information 1110 may include an identifier of the energy receiver 1200, one or more parameters of energy harvesting circuitry of the energy receiver 1200, such as information indicating one or more frequency bands, waveform configurations, beam-forming configurations, or precoding configurations in which the energy harvesting circuitry may function with greater efficiency, one or more input powers at which energy harvesting circuitry of the energy receiver 1200 may operate with greater efficiency, an amount of energy requested by the energy receiver 1200, such as an amount of energy required to power one or more components of the energy receiver 1200 or an amount of energy required to fully or partially charge an energy storage component of the energy receiver 1200, a time duration requested for a wireless energy transfer session from an energy transmitter 1100, an amount of energy requested from an energy transmitter 1100, such as a coarse amount of wireless energy transfer energy requested, e.g., 5 mJ or 100 mJ, or other energy transfer information 1110.

Energy transfer training logic 1112 may be configured to engage in an energy transfer training procedure with energy receiver 1200. For example, when wireless energy transfer is requested by energy receiver 1200, the energy transfer training logic 1112 may be configured to transmit one or more wireless energy transfer signals, such as wireless energy transfer training signals. Energy transfer logic 1114 may be configured to engage in a wireless energy transfer session with energy receiver 1200, such as to transmit one or more energy transfer signals based on energy transfer information 1110. For example, the energy transfer logic 1114 may be configured to transmit energy to energy receiver 1200 following a wireless energy transfer training session based on energy transfer information 1110 determined during the wireless energy transfer training session.

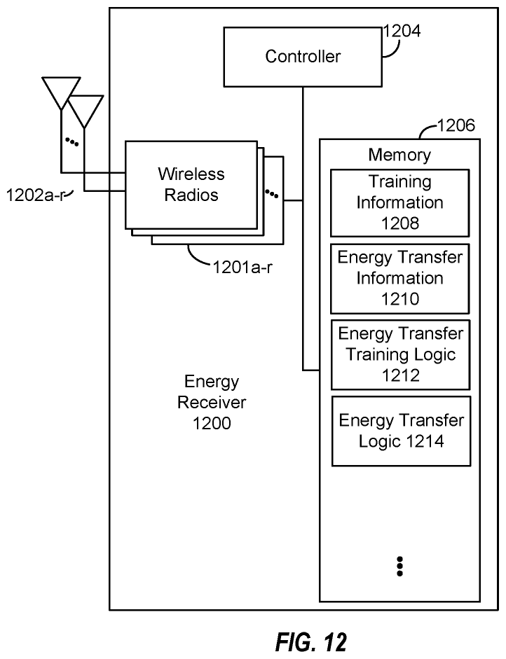

FIG. 12 is a block diagram of an example energy receiver 1200 that supports a wireless energy transfer service according to one or more aspects. Energy receiver 1200 may be configured to perform operations, including the blocks of a process described with reference to FIGS. 7-8. In some implementations, Energy receiver 1200 includes the structure, hardware, and components shown and described with reference to UE 115 of FIGS. 1-3. For example, energy receiver 1200 includes controller 1204, which may correspond to controller 280 and may operate to execute logic or computer instructions stored in memory 1206, which may correspond to memory 282, as well as controlling the components of energy receiver 1200 that provide the features and functionality of energy transmitter 1200. Energy transmitter 1200, under control of controller 1204, transmits and receives signals via wireless radios 1201a-r and antennas 1202a-r, which may correspond to antennas 252a-r. Wireless radios 1201a-r may include various components and hardware, as illustrated in FIG. 2 for UE 115, including modulator and demodulators 254a-r. MIMO detector 256, receive processor 258, transmit processor 264, and TX MIMO processor 266.

As shown, memory 1206 may include training information 1208, which may, for example, include wireless energy transfer training information received from energy transmitter 1100, such as one or more training parameters or measurements performed on one or more energy signals received from the energy transmitter 1100. Training parameters may, for example, include a length of a training session between the energy receiver 1200 and the energy transmitter, feedback resources for transmission of training feedback, such as wireless energy transfer parameters determined based on receipt of wireless energy transfer training information, information regarding one or more preferred bands for transmission of energy training signals, information regarding one or more channels of one or more preferred bands for transmission of energy training signals, information regarding one or more antennas the energy transmitter 404 will use for transmission of energy training signals, information regarding one or more beamforming, precoding, or optimized waveform, such as continuous waveform or multi-sine waveform, parameters that the energy transmitter 1100 will use for transmission of energy training signals. Memory 1206 may further include energy transfer information 1210, which may include, for example, energy transfer parameters determined by the energy receiver 1200 based on receipt of wireless energy transmission training signals from the energy transmitter 1100 during a training session. For example, the energy receiver 200 may perform one or more measurements on wireless energy transmission training signals transmitted by the energy transmitter 1100 during a training session and store the measurements as energy transfer information 1210. In some embodiments, energy transfer information 1210 may include information indicating one or more channels, bands, beam-forming parameters, precoding parameters, or optimized waveform parameters that may be used in transmitting energy from the energy transmitter 1100 to the energy receiver 1200. In some embodiments, energy transfer information 1210 may include an identifier of the energy receiver 1200, one or more parameters of energy harvesting circuitry of the energy receiver 1200, such as information indicating one or more frequency bands, waveform configurations, beam-forming configurations, or precoding configurations in which the energy harvesting circuitry may function with greater efficiency, one or more input powers at which energy harvesting circuitry of the energy receiver 1200 may operate with greater efficiency, an amount of energy to be requested by the energy receiver 1200, such as an amount of energy required to power one or more components of the energy receiver 1200 or an amount of energy required to fully or partially charge an energy storage component of the energy receiver 1200, a time duration to be requested for a wireless energy transfer session from an energy transmitter 1100, an amount of energy to be requested from an energy transmitter 1100, such as a coarse amount of wireless energy transfer energy to be requested, e.g., 5 mJ or 100 mJ, or other energy transfer information 1210.

Energy transfer training logic 1212 may be configured to engage in an energy transfer training procedure with energy transmitter 1100. For example, when wireless energy transfer is requested by energy receiver 1200, energy transfer training logic 1212 may be configured to receive one or more wireless energy transfer signals, such as wireless energy transfer training signals, and to perform one or more measurements on the one or more wireless energy transfer signals and for determining wireless energy transfer parameters based on the signals for transmission to energy transmitter 1100. Energy transfer logic 1214 may be configured to engage in a wireless energy transfer session with energy transmitter 1100.

It is noted that one or more blocks (or operations) described with reference to FIGS. 7-10 may be combined with one or more blocks (or operations) described with reference to another of the figures. For example, one or more blocks (or operations) of FIG. 7 may be combined with one or more blocks (or operations) of FIG. 8. As another example, one or more blocks associated with FIG. 9 may be combined with one or more blocks associated with FIG. 10. As another example, one or more blocks associated with FIG. 7 may be combined with one or more blocks (or operations) associated with FIGS. 1-4. Additionally, or alternatively, one or more operations described above with reference to FIGS. 1-4 may be combined with one or more operations described with reference to FIG. 11 or 12.

In one or more aspects, techniques for supporting a wireless energy transfer service may include additional aspects, such as any single aspect or any combination of aspects described below or in connection with one or more other processes or devices described elsewhere herein. In a first aspect, supporting a wireless energy transfer service may include an apparatus, such as a first network node, configured to receive, from a second network node, an indication that the second network node supports wireless energy transfer, transmit, to the second network node, a request for wireless energy transfer based on receipt of the indication that the second network node supports wireless energy transfer, and receive, from the second network node, energy for one or more components of the first network node after transmitting the request for wireless energy transfer. Additionally, the apparatus may perform or operate according to one or more aspects as described below. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, alone or in combination with one or more of the above aspects, the apparatus is further configured to receive, from the second network node, wireless energy transfer training transmission, determine one or more wireless energy transfer parameters based on receipt of the wireless energy transfer training transmission, and transmit, to the second network node, the one or more wireless energy transfer parameters.

In a third aspect, alone or in combination with one or more of the above aspects, to receive the wireless energy transfer training transmission the apparatus is configured to at least one of: receive, from the second network node, an indication of one or more training parameters, or receive, from the second network node, one or more energy transmission signals.

In a fourth aspect, alone or in combination with one or more of the above aspects, to receive the indication of one or more training parameters the apparatus is configured to receive at least one of: an indication of a length of a training session or an indication of one or more feedback resources of the training session.

In a fifth aspect, alone or in combination with one or more of the above aspects, to receive one or more energy transmission signals the apparatus is configured to receive at least one of: a plurality of energy transmission signals transmitted on different channels in a first band, a plurality of energy transmission signals transmitted using different antennas, or a plurality of energy transmission signals transmitted using different beam-forming, precoding, or waveform parameters.

In a sixth aspect, alone or in combination with one or more of the above aspects, the indication that the second network node supports wireless energy transfer comprises at least one of: an indication of a maximum deliverable energy supported by the second network node, an indication of a transmit energy of the second network node, an indication of one or more frequency bands for wireless energy transfer supported by the second network node, or an indication of one or more channels for wireless energy transfer supported by the second network node.

In a seventh aspect, alone or in combination with one or more of the above aspects, the request for wireless energy transfer comprises at least one of: an indication of an identifier of the first network node, an indication of an amount of requested energy, an indication of a time duration for requested energy transfer, or an indication of an energy storage capacity of the first network node.

In an eighth aspect, alone or in combination with one or more of the above aspects, the apparatus is configured to transmit, to the second network node, an indication that a requested amount of energy has been received.

In one or more aspects, techniques for supporting a wireless energy transfer service may include additional aspects, such as any single aspect or any combination of aspects described below or in connection with one or more other processes or devices described elsewhere herein. In a ninth aspect, supporting a wireless energy transfer service may include an apparatus, such as a first network node configured to transmit, to a second network node, an indication that the first network node supports wireless energy transfer, receive, from the second network node, a request for wireless energy transfer, and transmit, to the second network node, energy for one or more components of the second network node after receiving the request for wireless energy transfer. Additionally, the apparatus may perform or operate according to one or more aspects as described below. In some implementations, the apparatus includes a wireless device, such as a base station. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a tenth aspect alone or in combination with one or more of the above aspects, the apparatus is further configured to transmit, to the second network node, a wireless energy transfer training transmission and receive, from the second network node, one or more wireless energy transfer parameters in response to the wireless energy transfer training transmission.

In an eleventh aspect, alone or in combination with one or more of the above aspects, to transmit the wireless energy transfer training transmission the apparatus is configured to at least one of: transit, to the second network node, an indication of one or more training parameters or transmit, to the second network node, one or more energy transmission signals.

In a twelfth aspect, alone or in combination with one or more of the above aspects, to transmit the indication of one or more training parameters the apparatus is configured to transmit at least one of: an indication of a length of a training session or an indication of one or more feedback resources of the training session.

In a thirteenth aspect, alone or in combination with one or more of the above aspects, to transmit one or more energy transmission signals the apparatus is further configured to transmit at least one of: a plurality of energy transmission signals on different channels in a first band, a plurality of energy transmission signals using different antennas, or a plurality of energy transmission signals using different beam-forming, precoding, or waveform parameters.

In a fourteenth aspect, alone or in combination with one or more of the above aspects, the indication that the first network node supports wireless energy transfer comprises at least one of: an indication of a maximum deliverable energy supported by the first network node, an indication of a transmit energy of the first network node, an indication of one or more frequency bands for wireless energy transfer supported by the first network node, or an indication of one or more channels for wireless energy transfer supported by the first network node.

In a fifteenth aspect alone or in combination with one or more of the above aspects, the request for wireless energy transfer comprises at least one of: an indication of an identifier of the second network node, an indication of an amount of requested energy, an indication of a time duration for requested energy transfer, or an indication of an energy storage capacity of the second network node.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-4 and 11-12 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a device capable of receiving wireless energy transfer via a network, such as a device including a radio frequency identification (RFID) circuit for receiving wireless energy transfer. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a first network node, the method comprising:
receiving, by the first network node from a second network node, an indication that the second network node supports wireless energy transfer;
transmitting, by the first network node to the second network node, a request for wireless energy transfer based on receipt of the indication that the second network node supports wireless energy transfer; and
receiving, by the first network node from the second network node, energy for one or more components of the first network node after transmitting the request for wireless energy transfer.

2. The method of claim 1, further comprising:
receiving, by the first network node from the second network node, a wireless energy transfer training transmission;
determining, by the first network node, one or more wireless energy transfer parameters based on receipt of the wireless energy transfer training transmission; and
transmitting, by the first network node to the second network node, the one or more wireless energy transfer parameters.

3. The method of claim 2, wherein receiving the wireless energy transfer training transmission comprises at least one of:
receiving, from the second network node, an indication of one or more training parameters; or
receiving, from the second network node, one or more energy transmission signals.

4. The method of claim 3, wherein receiving the indication of one or more training parameters comprises receiving at least one of:
an indication of a length of a training session; or
an indication of one or more feedback resources of the training session.

5. The method of claim 3, wherein receiving one or more energy transmission signals comprises receiving at least one of:
a plurality of energy transmission signals transmitted on different channels in a first band;
a plurality of energy transmission signals transmitted using different antennas; or
a plurality of energy transmission signals transmitted using different beam-forming, precoding, or waveform parameters.

6. The method of claim 1, wherein the indication that the second network node supports wireless energy transfer comprises at least one of:
an indication of a maximum deliverable energy supported by the second network node;
an indication of a transmit energy of the second network node;
an indication of one or more frequency bands for wireless energy transfer supported by the second network node; or
an indication of one or more channels for wireless energy transfer supported by the second network node.

7. The method of claim 1, wherein the request for wireless energy transfer comprises at least one of:
an indication of an identifier of the first network node;
an indication of an amount of requested energy;
an indication of a time duration for requested energy transfer; or
an indication of an energy storage capacity of the first network node.

8. The method of claim 1, further comprising:
transmitting, by the first network node to the second network node, an indication that a requested amount of energy has been received.

9. A first network node comprising:
a memory; and
at least one processor coupled to the memory, wherein the at least one processor is configured to:
receive, from a second network node, an indication that the second network node supports wireless energy transfer;
transmit, to the second network node, a request for wireless energy transfer based on receipt of the indication that the second network node supports wireless energy transfer; and
receive, from the second network node, energy for one or more components of the first network node after transmitting the request for wireless energy transfer.

10. The first network node of claim 9, wherein the processor is further configured to:
receive, from the second network node, a wireless energy transfer training transmission;
determine one or more wireless energy transfer parameters based on receipt of the wireless energy transfer training transmission; and
transmit, to the second network node, the one or more wireless energy transfer parameters.

11. The first network node of claim 10, wherein to receive the wireless energy transfer training transmission the at least one processor is configured to at least one of:
receive, from the second network node, an indication of one or more training parameters; or
receive, from the second network node, one or more energy transmission signals.

12. The first network node of claim 11, wherein to receive the indication of one or more training parameters the at least one processor is further configured to receive at least one of:
an indication of a length of a training session; or
an indication of one or more feedback resources of the training session.

13. The first network node of claim 11, wherein to receive one or more energy transmission signals the at least one processor is further configured to receive at least one of:
a plurality of energy transmission signals transmitted on different channels in a first band;
a plurality of energy transmission signals transmitted using different antennas; or
a plurality of energy transmission signals transmitted using different beam-forming, precoding, or waveform parameters.

14. The first network node of claim 9, wherein the indication that the second network node supports wireless energy transfer comprises at least one of:
an indication of a maximum deliverable energy supported by the second network node;
an indication of a transmit energy of the second network node;
an indication of one or more frequency bands for wireless energy transfer supported by the second network node; or
an indication of one or more channels for wireless energy transfer supported by the second network node.

15. The first network node of claim 9, wherein the request for wireless energy transfer comprises at least one of:
an indication of an identifier of the first network node;
an indication of an amount of requested energy;
an indication of a time duration for requested energy transfer; or
an indication of an energy storage capacity of the first network node.

16. The first network node of claim 9, wherein the at least one processor is further configured to:
transmit, to the second network node, an indication that a requested amount of energy has been received.

17. A method of wireless communication performed by a first network node, the method comprising:
transmitting, by the first network node to a second network node, an indication that the first network node supports wireless energy transfer;
receiving, by the first network node from the second network node, a request for wireless energy transfer; and
transmitting, by the first network node to the second network node, energy for one or more components of the second network node after transmitting the request for wireless energy transfer.

18. The method of claim 17, further comprising:
transmitting, by the first network node to the second network node, a wireless energy transfer training transmission; and
receiving, by the first network node from the second network node, one or more wireless energy transfer parameters in response to the wireless energy transfer training transmission.

19. The method of claim 18, wherein transmitting the wireless energy transfer training transmission comprises at least one of:
transmitting, to the second network node, an indication of one or more training parameters; or
transmitting, to the second network node, one or more energy transmission signals.

20. The method of claim 19, wherein transmitting the indication of one or more training parameters comprises transmitting at least one of:
an indication of a length of a training session; or
an indication of one or more feedback resources of the training session.

21. The method of claim 19, wherein transmitting one or more energy transmission signals comprises transmitting at least one of:
a plurality of energy transmission signals on different channels in a first band;
a plurality of energy transmission signals using different antennas; or
a plurality of energy transmission signals using different beam-forming, precoding, or waveform parameters.

22. The method of claim 17, wherein the indication that the first network node supports wireless energy transfer comprises at least one of:
an indication of a maximum deliverable energy supported by the first network node;
an indication of a transmit energy of the first network node;
an indication of one or more frequency bands for wireless energy transfer supported by the first network node; or
an indication of one or more channels for wireless energy transfer supported by the first network node.

23. The method of claim 17, wherein the request for wireless energy transfer comprises at least one of:
an indication of an identifier of the first network node;
an indication of an amount of requested energy;
an indication of a time duration for requested energy transfer; or
an indication of an energy storage capacity of the second network node.

24. A first network node comprising:
a memory; and
at least one processor coupled to the memory, wherein the at least one processor is configured to:
transmit, to a second network node, an indication that the first network node supports wireless energy transfer;
receive, from the second network node, a request for wireless energy transfer; and
transmit, to the second network node, energy for one or more components of the second network node after receiving the request for wireless energy transfer.

25. The first network node of claim 24, wherein the processor is further configured to:
transmit, to the second network node, a wireless energy transfer training transmission; and
receive, from the second network node, one or more wireless energy transfer parameters in response to the wireless energy transfer training transmission.

26. The first network node of claim 25, wherein to transmit the wireless energy transfer training transmission the at least one processor is configured to at least one of:
transit, to the second network node, an indication of one or more training parameters; or
transmit, to the second network node, one or more energy transmission signals.

27. The first network node of claim 25, wherein to transmit the indication of one or more training parameters the at least one processor is further configured to transmit at least one of:
an indication of a length of a training session; or
an indication of one or more feedback resources of the training session.

28. The first network node of claim 25, wherein to transmit one or more energy transmission signals the at least one processor is further configured to transmit at least one of:
a plurality of energy transmission signals on different channels in a first band;
a plurality of energy transmission signals using different antennas; or
a plurality of energy transmission signals using different beam-forming, precoding, or waveform parameters.

29. The first network node of claim 24, wherein the indication that the first network node supports wireless energy transfer comprises at least one of:
an indication of a maximum deliverable energy supported by the first network node;
an indication of a transmit energy of the first network node;
an indication of one or more frequency bands for wireless energy transfer supported by the first network node; or
an indication of one or more channels for wireless energy transfer supported by the first network node.

30. The first network node of claim 24, wherein the request for wireless energy transfer comprises at least one of:
an indication of an identifier of the second network node;
an indication of an amount of requested energy;
an indication of a time duration for requested energy transfer; or
an indication of an energy storage capacity of the second network node.
